(19) United States
(12) Patent Application Publication
(10) Pub. No.: US 2010/0018035 A1
(43) Pub. Date: Jan. 28, 2010

(54) FABRICATION METHOD OF BATTERY PACK DEVICE

(75) Inventor: Fumitaka Okano, Higashiosaka-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: SANYO ELECTRIC CO., LTD., Osaka (JP); SANYO TUNER INDUSTRIES CO., LTD., Osaka (JP)

(21) Appl. No.: 12/505,641

(22) Filed: Jul. 20, 2009

(30) Foreign Application Priority Data
Jul. 22, 2008 (JP) 2008188945

(51) Int. Cl. H01M 2/02

(52) U.S. Cl. 29/623.2

(57) ABSTRACT

A fabrication method of battery pack device includes the steps of: preparing a plurality of protection circuit substrates disposed apart from each other in a space of a frame, and supported to the frame via a bridge member; attaching a connector component to a top face side of each of the protection circuit substrates; moving a leading end of a sealing material feeder towards the connector component from a bottom side of the protection circuit substrate and supplying a sealing material to a bottom end of the connector component; infiltrating the sealing material into a gap between the connector component and the protection circuit substrate, along a circumference at the bottom end of the connector component to seal the gap with the sealing material.

### BACKGROUND OF THE INVENTION

1. Field of the Invention

The present invention relates to a fabrication method of a battery pack device including a plurality of protection circuit substrates arranged apart from each other in the space of a frame, a plurality of connector components, and a battery body, all integrated with mold resin.

2. Description of the Background Art

A connector device having a protection circuit substrate and connector component integrated with each other is conventionally employed for a battery pack in order to establish connection between the battery pack and, for example, the telephone unit of a cellular phone. A connector device is formed of a predetermined protection circuit substrate, and a connector component affixed to the protection circuit substrate. By inserting a terminal of the telephone unit to the connector component, the electric power of the battery pack is supplied to the cellular phone. One type of connector device is sealed with the battery pack body by mold resin to constitute an integral unit.

A fabrication method of this type of connector device will be described hereinafter. As shown in FIG. 11, there are prepared a plurality of protection circuit substrates 10 spaced apart from each other in a space of a frame 110, supported by frame 110 via a bridge member. A predetermined circuit pattern 1110a is formed at each of protection circuit substrates 10. Circuit pattern 1110a includes a land 1120 connected to a connector component 20. Solder paste is applied on circuit pattern 1110a. A connector component 20 (strips), an electronic component 1130, and the like are mounted on circuit pattern 1110a with solder paste (not shown) therebetween.

The top face of protection circuit substrate 10 where connector component 20, electronic component 1130, and the like are mounted (the face on which the connector component is disposed) is upturned. The protection circuit substrate 10 is passed through a reflow furnace being tilted for solder-bonding connector component 20, electronic component 1130 and the like to the circuit pattern.

As shown in FIG. 12, a width W4 of connector component 20 is set smaller than a width W3 of a battery pack body 50. Taking into account variation in the dimension of protection circuit substrate 10 and the positioning accuracy of electronic component 1130 during the step of mounting connector component 20 on protection circuit substrate 10, connector component 20 and protection circuit substrate 10 are disposed and solder-bonded such that an end face 118 of protection circuit substrate 10 protrudes outer than an end face 27 of connector component 20.

Then, as shown in FIG. 13, a sealing material 4 is supplied through a nozzle 71 of a sealing material feeder with the connector device protection circuit substrate 10 tilted to the shorter side direction of connector component 20 that is disposed on the top face of protection circuit substrate 10. Accordingly, the gap between connector component 20 and protection circuit substrate 10 is sealed by sealing material 4. Then, the bridge member is cut from frame 10, as shown in FIG. 11, so that the region of protection circuit substrate 10 is divided. Thus, a connector device 26 (refer to FIG. 17) having protection circuit substrate 10 and connector component 20 formed integrally is completed.

Then, connector device 26 and battery pack body 50 are set integrally by mold resin 6 to complete a battery pack 17, as shown in FIG. 17. A terminal (not shown) of the telephone set unit is inserted to a connection terminal 220 of connector component 20 exposed at the surface of battery pack 17, whereby electric power is supplied. For example, Japanese Patent Laying-Open No. 2000-69137 is cited as a document disclosing a battery pack for a cellular phone or the like.

The conventional fabrication method of connector device 26 had the following problems. In the case where the thickness W5 of battery pack body 5 becomes so thin that the size of connector component 2 and the connection with protection circuit substrate 1 may have to be revised, supply of sealing material 4 from above connector component 2 (the top face side of protection circuit substrate 1) to the bottom end of connector component 2 will cause nozzle 71 of the sealing material feeder to collide against a second end face 23 that is the leading end face of projection 9 of connector component 2, inducing the problem that sealing material 4 cannot be supplied.

If there is only one protection circuit substrate 1, sealing material 4 can be applied by increasing the tilt. However, in the case where protection circuit substrates 1 are arranged apart from each other as in FIG. 16, a large tilt will cause nozzle 71 of the sealing material feeder to collide against the closest connector unit 2, leading to the problem that sealing material 4 cannot be supplied. Although collision of nozzle 71 of the sealing material feeder can be avoided if the distance between the plurality of connector components 2 (or protection circuit substrates 1) disposed apart from each other in FIG. 1 is increased, the productivity will then be degraded to lead to increase of the cost.

Even if collision of nozzle 71 against second end face 23 that is the leading end of projection 9 of connector component 2 is not initially encountered, this collision may eventually occur due to the attachment of sealing material 4 to the leading end of nozzle 71 during the repetitive usage of nozzle 71 of the sealing material feeder, i.e. the diameter of the leading end of nozzle 71 being increased.

### SUMMARY OF THE INVENTION

In view of the foregoing, an object of the present invention is to provide, with favorable productivity, a battery pack employing a connector device having reliable connection between the connector device and a main body such as a cellular phone.

A fabrication method of a battery pack device according to the present invention includes the steps of: preparing a plurality of protection circuit substrates disposed apart from each other in a space of a frame, and supported to the frame via a bridge member; attaching a connector component to a top face side of each of the protection circuit substrates; moving a leading end of a sealing material feeder towards the connector component from a bottom side of the protection circuit substrate and supply a sealing material to a bottom end of the connector component; infiltrating the sealing material into a gap between the connector component and the protection circuit substrate, along a circumference at the bottom end of the connector component to seal the gap with the sealing material; cutting the bridge member to separate each of the protection circuit substrates from the frame; and attaching a battery pack body to the bottom side of the protection circuit substrate, and resin-molding the battery pack body, the protection circuit substrate and the connector component as a unitary element.

Preferably, the protection circuit substrate and connector component constitute a strip. The connector component includes a first end face along one of longitudinal sides of the connector component, and a projection. The projection includes a second end face. The protection circuit substrate includes a first protection circuit substrate end face along one of longitudinal sides of the protection circuit substrate. The first protection circuit substrate end face is set flush with the first end face or protruding outer than the first end face.

Preferably, the width between the second end face of the projection of the connector component and an end face of a housing, opposite to the second end face of the projection is equal to the thickness of the battery pack body.

According to the configuration of the present invention set forth above, a sealing material is supplied and infiltrated to the bottom end of the connector component without the nozzle of a sealing material feeder colliding against the connector component, allowing the gap between the connector component and protection circuit substrate to be sealed.

The presence of a projection at the connector component allows the resin not flowing into the gap between the connector unit and circuit body to be held back even if the sealing material is supplied from a face of the protection circuit substrate where the connector component is not connected.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view of a connector device according to a first embodiment of the present invention.

FIG. 2 is a perspective view of the connector device of the first embodiment viewed from the bottom side.

FIG. 3 is a perspective view of the top surface of protection circuit substrates of the connector device of the first embodiment.

FIG. 4 is a perspective view of the bottom of protection circuit substrates with components attached via solder paste in the connector device of the first embodiment.

FIG. 5 is a perspective view of the connector device of the first embodiment, with the bottom of protection circuit substrates attached to a jig.

FIG. 6 is a perspective view of the bottom of protection circuit substrates subsequent to component attachment by the passage of the connector device of the first embodiment through a reflow furnace.

FIG. 7 is a perspective view of the surface of protection circuit substrates with the connector components attached according to the first embodiment.

FIG. 8 is a sectional view of the connector component of FIG. 7 taken along line VIII-VIII, represented in an inclined manner.

FIGS. 9A and 9B are perspective views representing the step of supplying sealing material to the connector component according to the first embodiment.

FIG. 10 is a perspective view representing the step of attaching a connector device and a battery pack according to the first embodiment of the present invention.

FIG. 11 is a perspective view representing the step of attaching a connector component to a protection circuit substrate according to prior art.

FIG. 12 represents comparison in width between a connector component and battery pack body according to prior art.

FIG. 13 represents the step of supplying sealing material to a connector component and protection circuit substrate according to a conventional method.

FIG. 14 represents comparison in width between the connector component and battery pack body according to the first embodiment of the present invention.

FIG. 15 is a diagram to describe supply of sealing material according to a conventional method.

FIG. 16 is a diagram to describe the supply of sealing material being disabled according to a conventional method.

FIG. 17 is a perspective view of the step of attaching a connector device and battery pack according to a conventional method.

### DESCRIPTION OF THE PREFERRED EMBODIMENTS

### First Embodiment

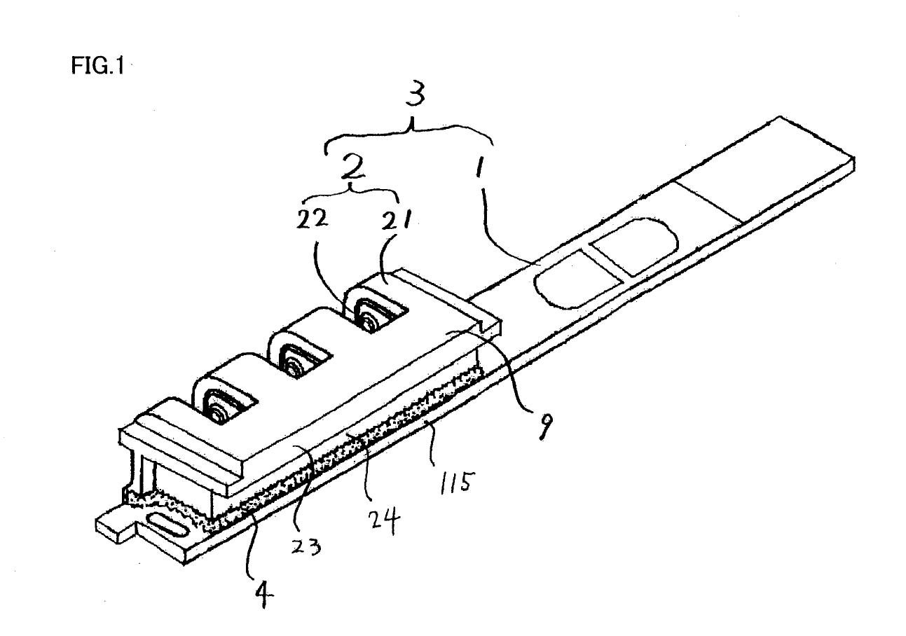

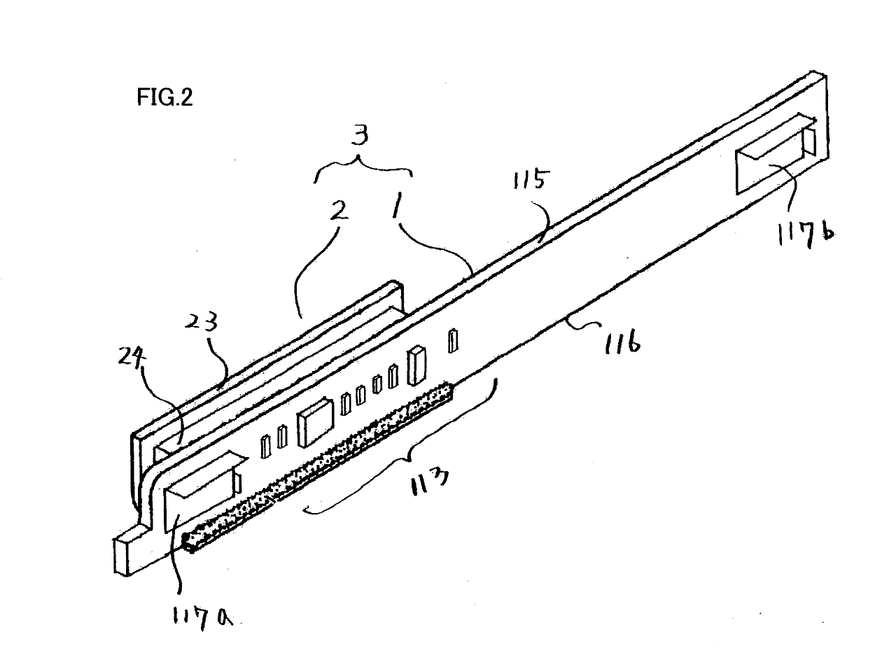

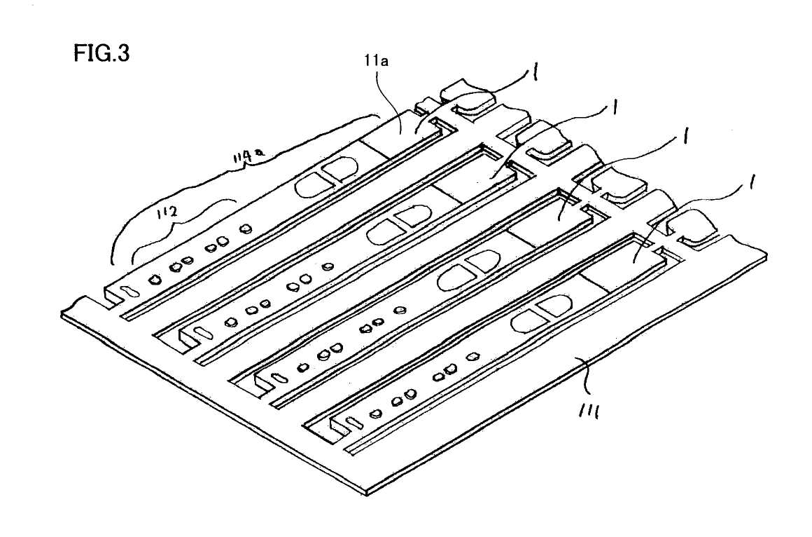

A connector device used in a battery pack of a cellular phone will be described hereinafter as a connector device 3 integrated with a protection circuit substrate 1 and a connector component 2 according to a first embodiment of the present invention. Referring to FIGS. 1 and 2, connector device 3 is configured to include protection circuit substrate 1 and connector component 2. Connector component 2 includes a housing 21, and a connection terminal 22 located in housing 21. Connection terminal 22 is connected to a land 112 (refer to FIG. 3) formed at protection circuit substrate 1.

A first protection circuit substrate end face 115 of protection circuit substrate 1 is set flush with or protruding outer than a first end face 24 of housing 21 in connector component 2.

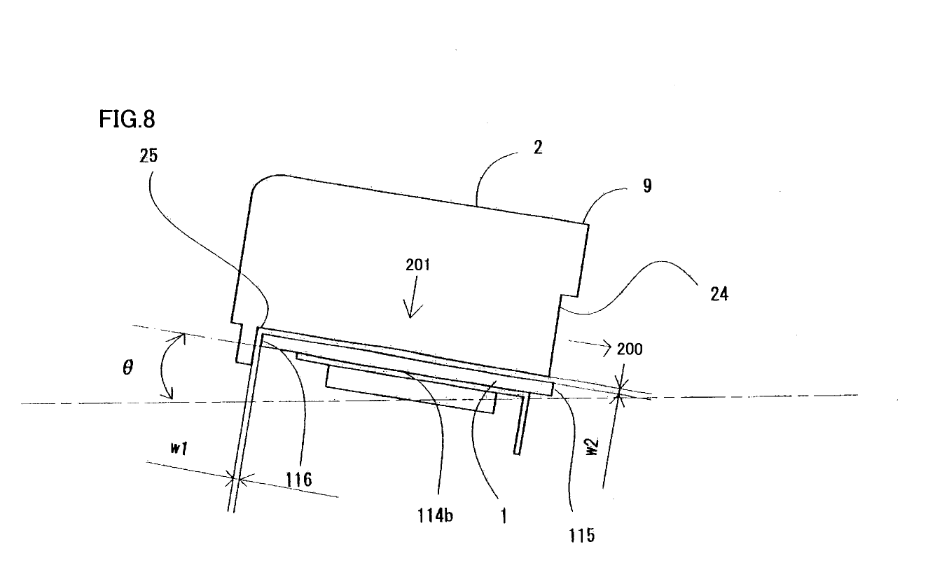

Protection circuit substrate 1 also includes an end face 116, opposite to first protection circuit substrate end face 115. For the purpose of registration between connector component 2 and protection circuit substrate 1, housing 21 includes an end face 25, opposite to end face 116 of protection circuit substrate 1 (refer to FIG. 8).

Predetermined circuit patterns 114a and 114b are formed at a top face 11a of protection circuit substrate 1 (the face where connector component 2 is connected) and at a bottom 11b (the face where connector component 2 is not connected). A predetermined electronic component 113, and Ni plates 117a and 117b are mounted at circuit patterns 114a and 114b.

In connector device 3, a sealing material 4 is supplied for infiltration so as to seal the gap between connector component 2 and protection circuit substrate 1. This infiltration of sealing material 4 between the gap prevents mold resin 6 from entering connector component 2 from the gap during the sealing of connector device 3 integrally with battery pack body 5 by mold resin 6. Since connection terminal 22 furnished in connector component 2 is not covered with mold resin 6, connector device 3 and the cellular phone main body can be rendered conductive reliably.

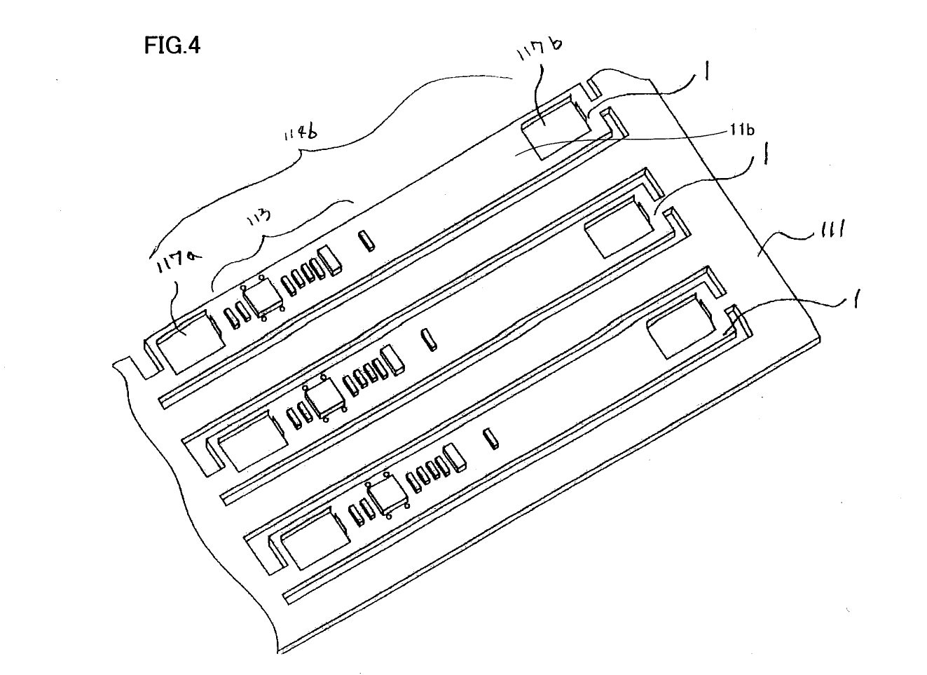

An example of a fabrication method of a battery pack device employing connector device 3 will be described hereinafter. Referring to FIGS. 3 and 4, there is prepared a frame 111 whose relevant areas are equivalent to top face 11a and bottom face 11b of a plurality of protection circuit substrates 1 supported by frame 111 via a bridge member. Protection circuit substrates 1 are disposed apart from each other in the space of frame 111. Circuit pattern 114a includes land 112 to which connector component 2 is connected. The plurality of protection circuit substrates 1 are cut off eventually from frame 111 to be individually separated as a protection circuit substrate.

The step of connecting protection circuit substrate 1 with connector component 2 that includes connection terminal 22 electrically connected to a predetermined terminal of protection circuit substrate 1 and a housing 21 holding and covering connection terminal 22 will be described hereinafter. Referring to FIG. 4, lead (Pb)-free solder paste (not shown) is applied on circuit pattern 114b using a metal mask or the like (not shown). Predetermined electronic component 113 and Ni plates 117a and 117b are mounted with solder paste thereunder.

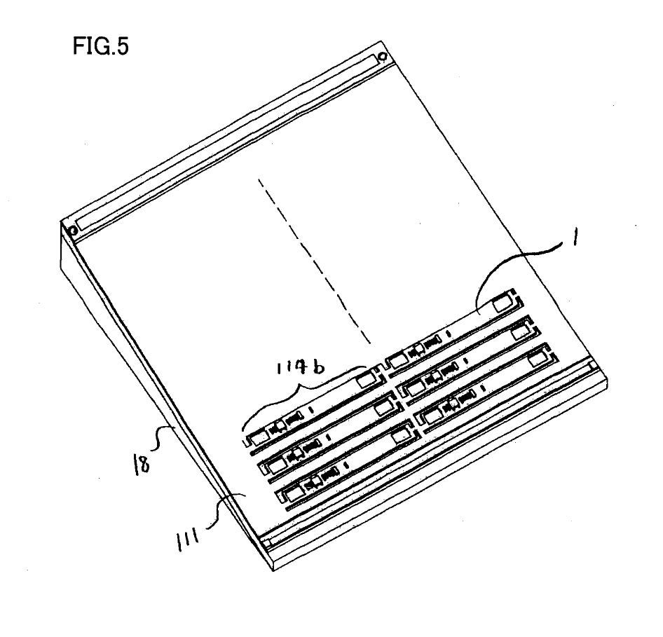

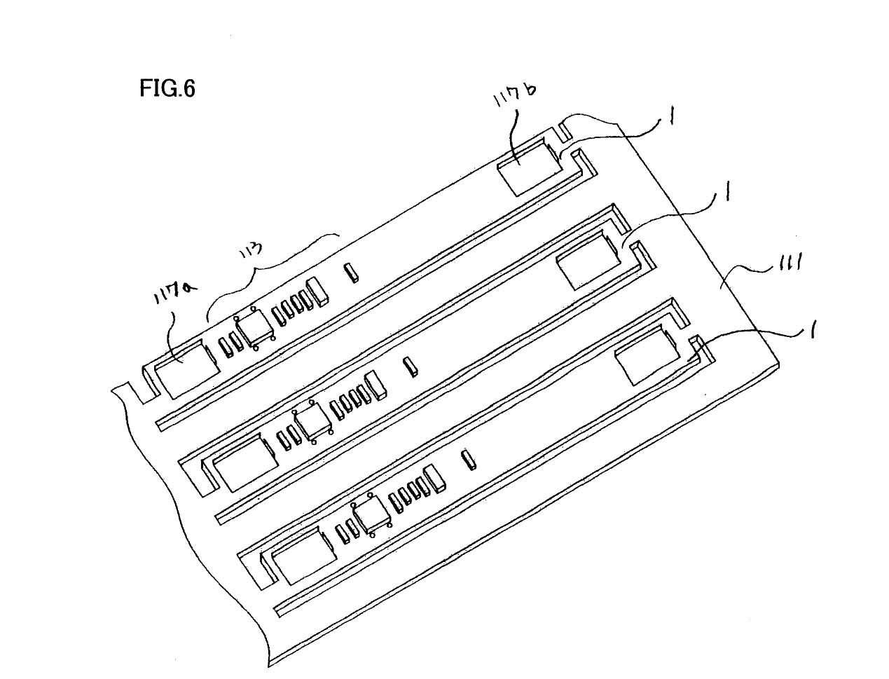

Referring to FIG. 5, with circuit pattern 114b formed at bottom 11b of protection circuit substrate 1 facing upward, a jig 18 is attached such that frame 111 is tilted in the shorter side direction of protection circuit substrate 1, followed by passage through a reflow furnace to solder-bond electronic component 113, Ni plates 117a and 117b, or the like to protection circuit substrate 1. Accordingly, electronic component 13, and Ni plates 117a and 117b are solder-bonded, as shown in FIG. 6. In the reflow furnace, heat treatment of several ten seconds in duration is carried out at the temperature of approximately 230° C. to 250° C., for example.

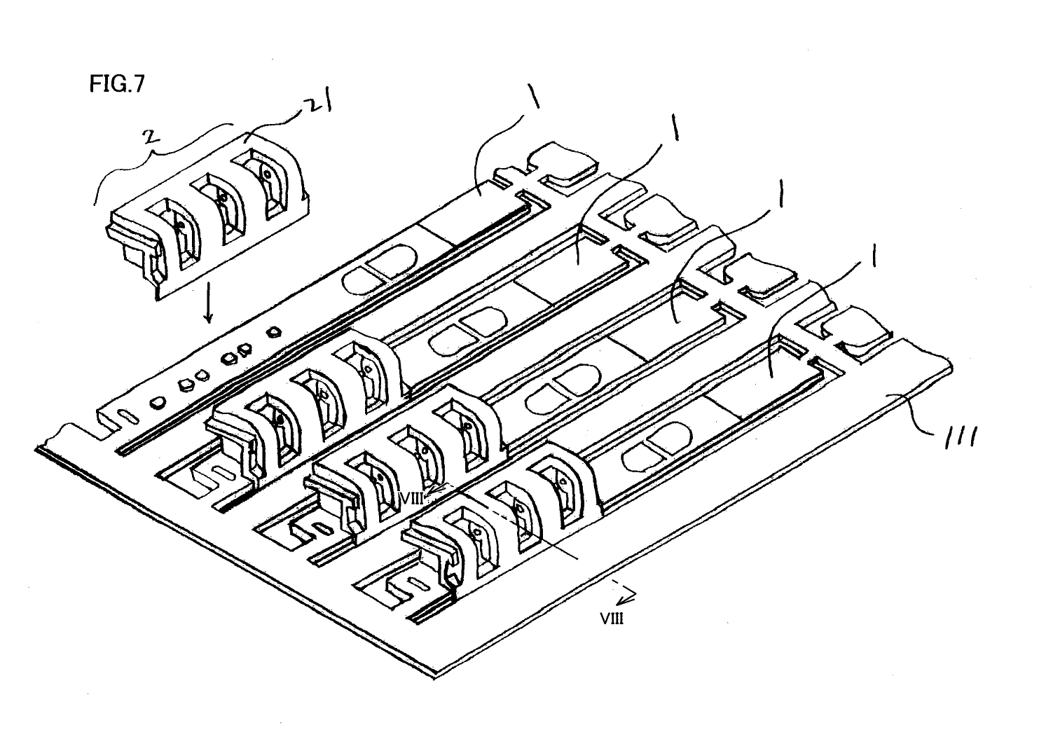

Referring to FIG. 7, lead (Pb)-free solder paste (not shown) is applied on circuit pattern 114a using a metal mask (not shown) or the like, and connector component 2 is mounted with solder paste thereunder at the region of land 112 relevant to connector component 2, at the top face 11a side of protection circuit substrate 1.

Further, with circuit pattern 114a formed at top face 11a of protection circuit substrate 1 facing upward, a jig 18 is attached such that frame 111 is tilted in the shorter side direction of protection circuit substrate 1, as in FIG. 5, followed by passage through a reflow furnace to solder-bond connector component 2 to protection circuit substrate 1. In the reflow furnace, heat treatment is applied for the duration of several ten seconds at the temperature of approximately 230° C. to 250° C., for example.

The relationship between connector component 2 and protection circuit substrate 1 will be described with reference to the sectional view of the connector component of FIG. 7 taken along line VIII-VIII. The solder paste melts by the heat treatment in the reflow furnace. Accordingly, connector component 2 in a tilted posture slides (arrow 200), so that an end face 25 of connector component 2 approaches end face 116 of protection circuit substrate 1. In the event of end face 25 brought into contact with a region of end face 116, connector component 2 will not slide any further. Connector component 2 is registered at a predetermined position in self-alignment with respect to end face 116.

Although circuit pattern 114b formed at bottom 11b of protection circuit substrate 1 faces downwards, electronic component 113 and the like will not fall off from protection circuit substrate 1 even by passage through the reflow furnace by selecting appropriate conditions for the reflow furnace and by the event of electronic component 113 and the like being coupled to protection circuit substrate 1 with the solder paste once melting.

There may still be a small gap W1 between end face 25 of connector component 2 and end face 116 of protection circuit substrate 1, as shown in FIG. 8. Furthermore, the melting of the solder paste will cause the solder to flow, so that connector component 2 settles downwards (arrow 201). Accordingly, the gap between the bottom end of connector component 2 and protection circuit substrate 1 becomes smaller. However, there may still be a small gap W2 between the bottom end of connector component 2 and protection circuit substrate 1, depending upon the initial thickness of the solder paste.

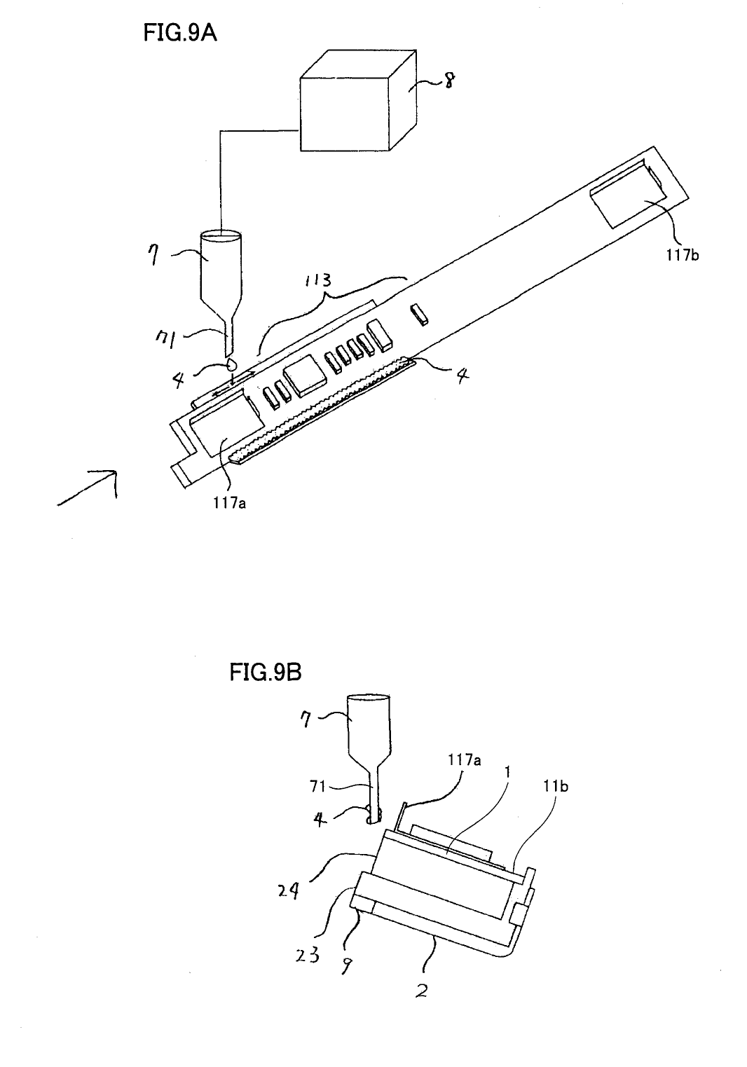

In view of such a gap, the step of supplying sealing material 4 to fill the gap between connector component 2 and protection circuit substrate 1 includes the step set forth below, as shown in FIGS. 9A and 9B. With protection circuit substrate 1 facing downwards and tilted in the shorter side direction of connector component 2, a dispenser 8 and a syringe 7 that are sealing material supply devices are used to apply sealing material 4 from a nozzle 71 of syringe 7. Here, silicone resin was used as sealing material 4. At this stage, supply sealing material 4 may be supplied for infiltration with frame 111 placed on a jig identical to that passed through the reflow furnace. When sealing material 4 is supplied, the sealing material is infiltrated to seal the gap between the bottom end of connector component 2 and protection circuit substrate 1 by a capillary action, followed by drying sealing material 4 at ambient temperature. Thus, sealing material 4 is cured, and the gap filled. Sealing material 4 in the drawing runs from the top face of protection circuit substrate 1.

By setting bottom face 11b of protection circuit substrate 1 upwards, as shown in FIG. 9B when sealing material 4 is to be supplied, the productivity will not be degraded since collision of nozzle 71 against second end face 23 of projection 9 in housing 21 will not occur, and increasing the distance between protection circuit substrates 1 in frame 111 is not required.

Even if sealing material 4 is supplied with the bottom of protection circuit substrate 1 facing upwards, the presence of projection 9 at housing 21 allows sealing material 4 that did not flow around connector component 2 to be held back.

Then, the step of cutting protection circuit substrates 1 from frame 11 to separate each other is carried out. Thus, connector device 3 with connector component 2 attached to protection circuit substrate 1 is completed, as shown in FIGS. 1 and 2.

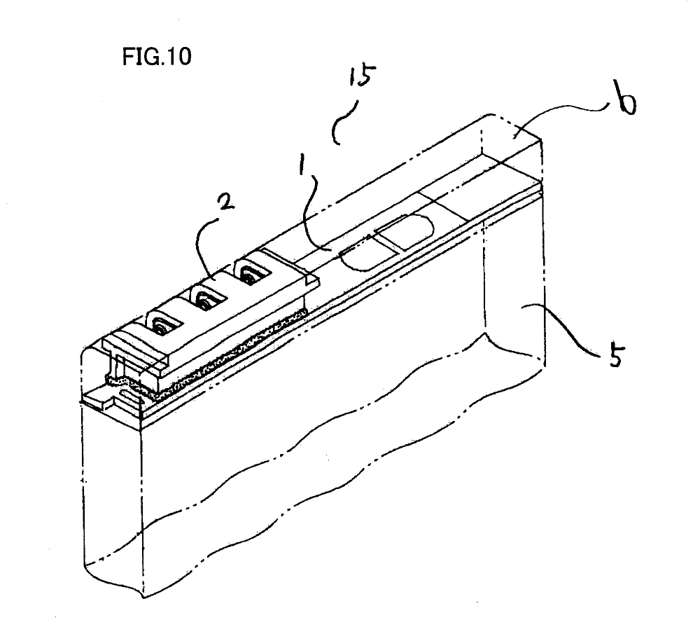

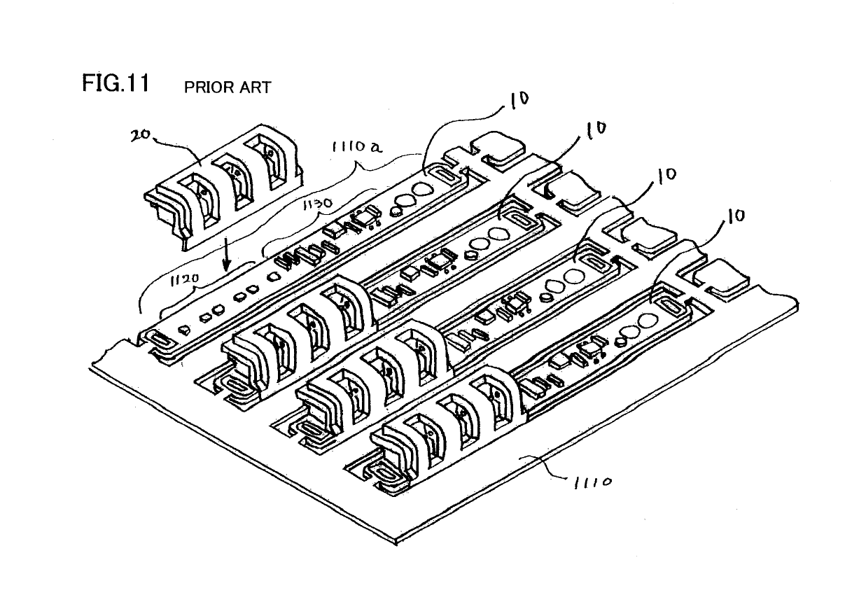

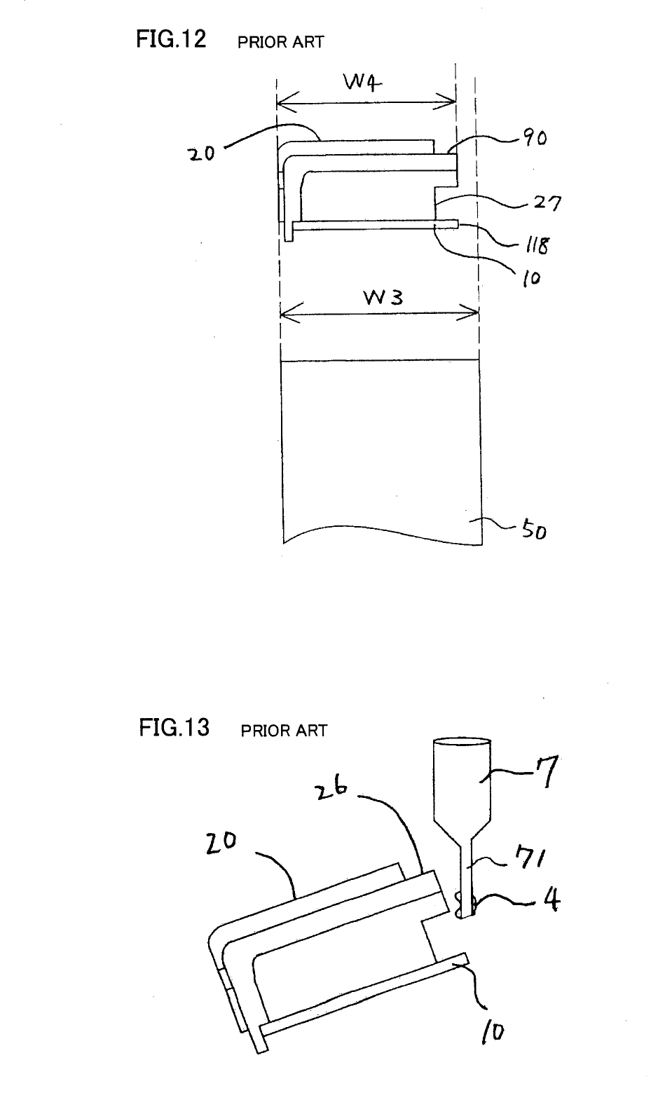

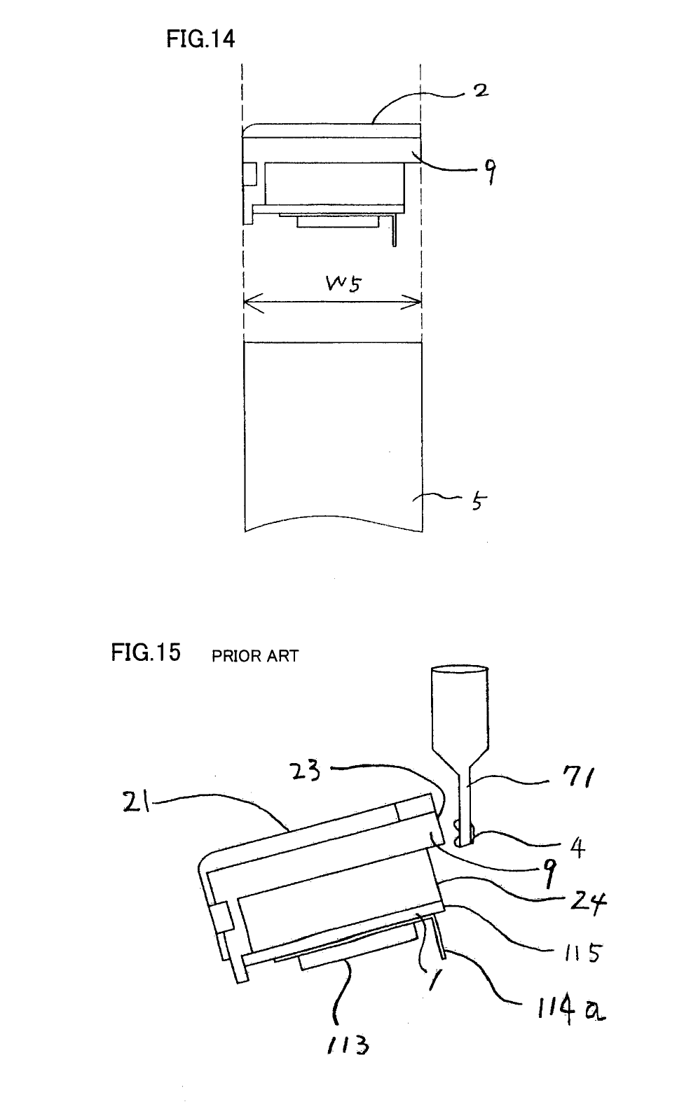

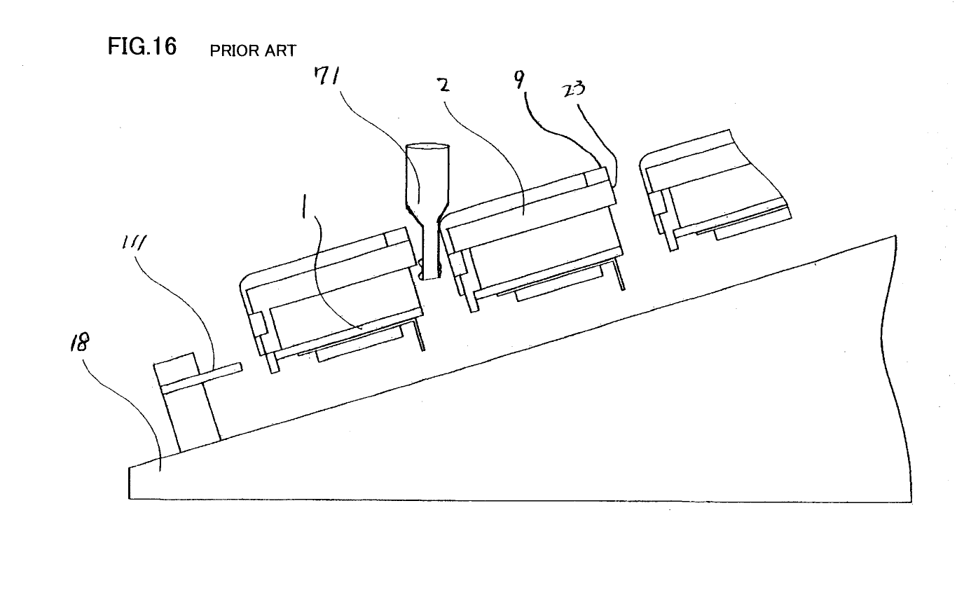

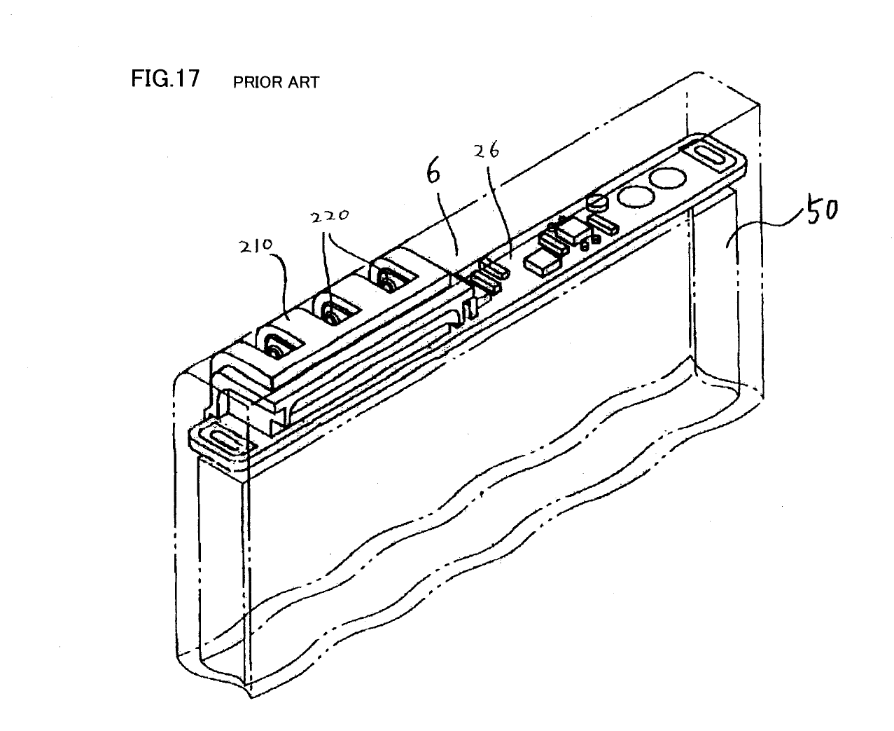

The step of integrating battery pack body 5, protection circuit substrates 1 and connector component 2 with mold resin 6 will be described hereinafter. Referring to FIG. 10, connector device 3 including protection circuit substrates 1 and connector component 2 is disposed at a predetermined position with respect to battery pack body 5 in which batteries are installed. Connector device 3 and battery pack body 5 are disposed in a predetermined mold (not shown). By introducing mold resin 6 into a metal casing, connector device 3 and battery pack body 5 are sealed integrally by mold resin 6. Then, they are taken out from the mold. Thus, a battery pack 15 having connector device 3 and battery pack body 5 sealed by mold resin 6 is completed. A connection terminal 22 is exposed at connector component 2 of battery pack 15.

In connector device 3 set forth above, silicone resin was employed as sealing material 4 to seal the gap between connector component 2 and protection circuit substrate 1. In the case where the gap is sealed taking advantage of a capillary phenomenon, another sealing material may be employed.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A fabrication method of a battery pack device, comprising the steps of:
preparing a plurality of protection circuit substrates disposed spaced apart from each other in a space of a frame, and supported to said frame via a bridge member,
attaching a connector component to a top face side of each of said protection circuit substrates,
moving a leading end of a sealing material feeder towards said connector component from a bottom side of said protection circuit substrate and supplying sealing material to a bottom end of said connector component,
infiltrating said sealing material into a gap between said connector component and said protection circuit substrate along a circumference at the bottom end of said connector component to seal said gap with said sealing material,
cutting said bridge member to separate each of said protection circuit substrate from said frame, and
attaching a battery pack body to the bottom side of said protection circuit substrate, and resin-molding said battery pack body, said protection circuit substrate and said connector component as a unitary element.

2. The fabrication method of a battery pack device according to claim 1, wherein
said protection circuit substrate and connector component constitute a strip,
said connector component includes a first end face along one of longitudinal sides of said connector component, and a projection,
said projection includes a second end face,
said protection circuit substrate includes a first protection circuit substrate end face along one of longitudinal sides of said protection circuit substrate, and
said first protection circuit substrate end face is set flush with said first end face or protruding outer than said first end face.

3. The fabrication method of a battery pack device according to claim 1, wherein a width between a second end face of a projection of said connector component and an end face of a housing, opposite to said second end face of said projection, is equal to a thickness of said battery pack body.

4. The fabrication method of a battery pack device according to claim 2, wherein a width between said second end face of said projection of said connector component and an end face of a housing, opposite to said second end face of said projection, is equal to a thickness of said battery pack body.
